(19) United States
(12) Patent Application Publication
(10) Pub. No.: US 2017/0212411 A1
(43) Pub. Date: Jul. 27, 2017

(54) Camera support and concealment device

(71) Applicant: William Henriques, Montreal (CA)

(72) Inventor: William Henriques, Montreal (CA)

(21) Appl. No.: 14/603,588

(22) Filed: Jan. 23, 2015

(51) Int. Cl. G03B 17/56; F16M 13/02; H04N 7/18

(52) U.S. Cl. CPC G03B 17/561; H04N 7/183; F16M 13/02; H04N 7/188; H04M 1/0264

(57) ABSTRACT

A camera support and concealment device consists in a hollow frame member having a center opening therethrough and an opened back portion, a transparent panel adapted to fit within the frame member center opening, an opaque panel adapted to fit within the frame member center opening adjacent a backside of the transparent panel, and including at least one spy hole therethrough, a concealment compartment member adapted to fit within the frame member center opening adjacent a backside of the opaque panel, and including an opening therethrough adapted to hold a device that includes at least one camera therein, such that the at least one camera is capable of being aligned and capturing images through the concealment compartment member opening, the at least one opaque panel spy hole, the transparent panel, and the frame member center opening, and a backing board member adapted to removably attach to the frame member, cover the opened back portion, and enclose the panels, the concealment compartment, and the device within the frame member.

### FIELD OF THE INVENTION

The present invention relates generally to surveillance devices but more particularly to a camera support and concealment device.

### BACKGROUND OF THE INVENTION

Several instances of problems involving babysitters have prompted parents to buy surveillance camera equipment to keep a record of babysitters behavior. With the advent of cheap and compact home cameras, it becomes easier to take a generic camera and use it instead of investing in expensive surveillance cameras. The problem is to find an easy and practical way of concealing the generic camera.

### SUMMARY OF THE INVENTION

In view of the foregoing disadvantages inherent in the known devices now present in the prior art, the present invention, which will be described subsequently in greater detail, is to provide objects and advantages which are:

To provide for a camera support and concealment device.

In order to do so, the invention consists in a hollow frame member having a center opening therethrough and an opened back portion, a transparent panel adapted to fit within the frame member center opening, an opaque panel adapted to fit within the frame member center opening adjacent a backside of the transparent panel, and including at least one spy hole therethrough, a concealment compartment member adapted to fit within the frame member center opening adjacent a backside of the opaque panel, and including an opening therethrough adapted to hold a device that includes at least one camera therein, such that the at least one camera is capable of being aligned and capturing images through the concealment compartment member opening, the at least one opaque panel spy hole, the transparent panel, and the frame member center opening, and a backing board member adapted to removably attach to the frame member, cover the opened back portion, and enclose the panels, the concealment compartment, and the device within the frame member.

The device has the frame member center opening include a ridge member there around adapted to hold the panels and the concealment compartment thereon.

The device has the hollow frame member include a plurality of rib members attached between inner side walls of the frame member and the center opening ridge member to thereby increase the strength and rigidity of the device.

The device has the backing board member include a bracket member thereon adapted to hold the device in a standing position upon a flat surface when in use.

In one embodiment, the device has the opaque panel include two spy holes adapted to allow the use of two cameras within the device.

The device has the concealment compartment member are made from injection molded plastic. The transparent panel is glass, and the back that closes the spy hole is made of pressed wood.

The device has the concealment compartment member opening include a ridge member there around adapted to hold the device that includes the at least one camera thereon, and wherein the ridge member is made from resilient injection moulded rubber shaped according to specific brands of phones.

Preferably, the device works in combination with a camera apparatus.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Exploded view of the invention.

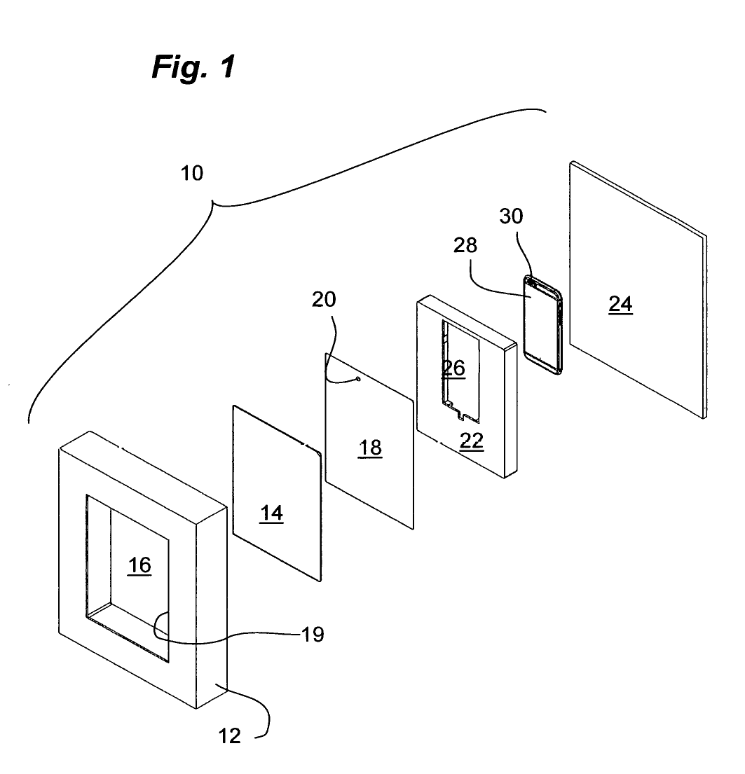

FIG. 2 Isometric see through view of the invention.

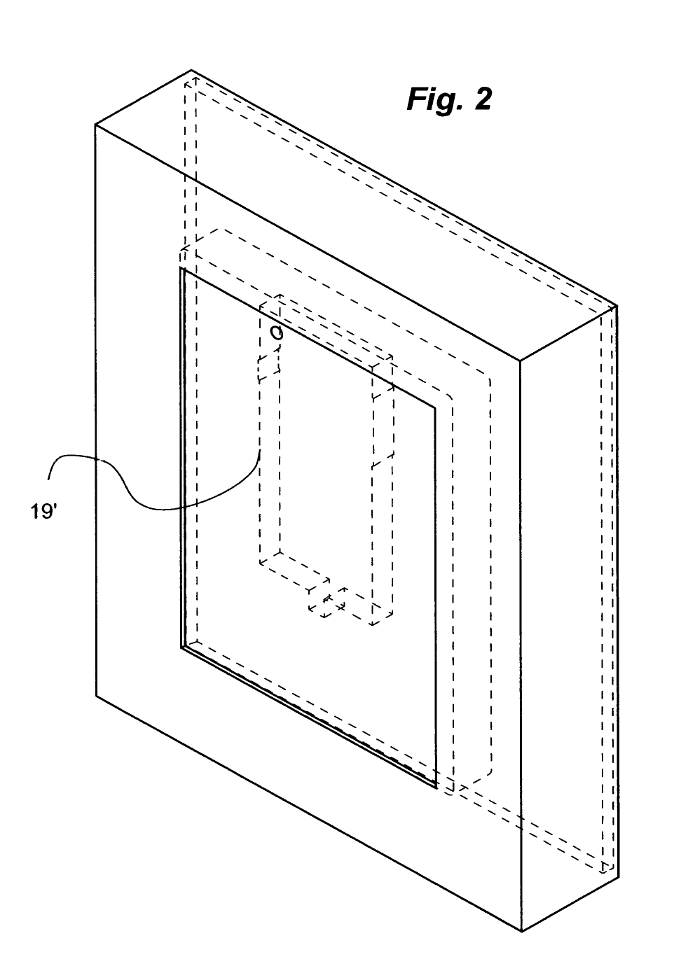

FIG. 3 Reverse angle of FIG. 2.

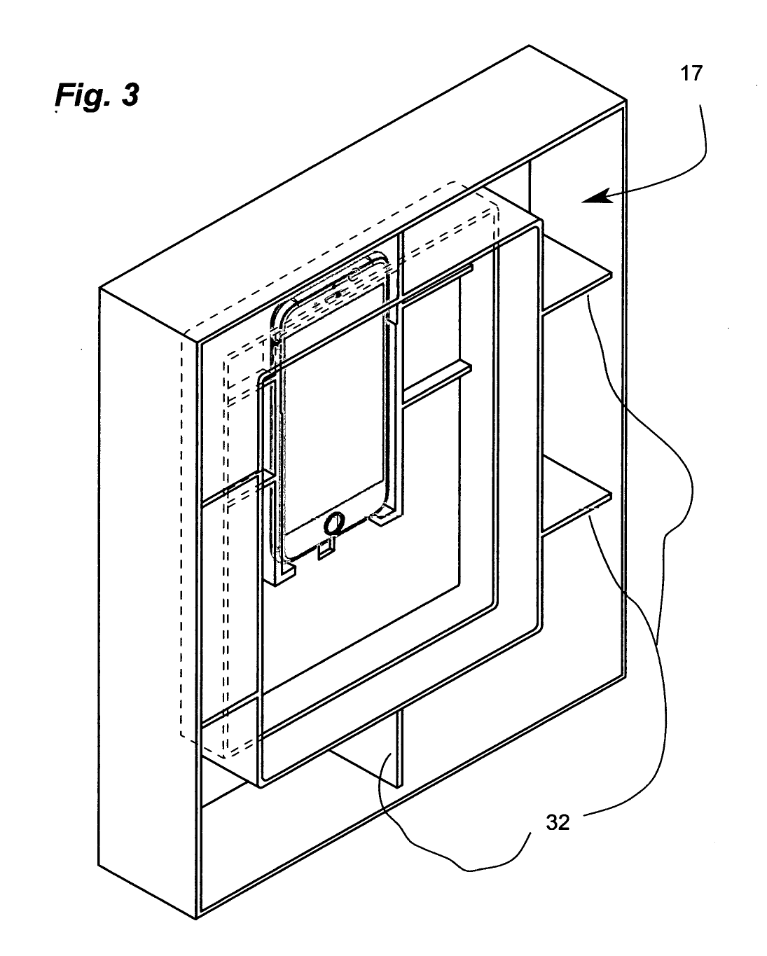

FIG. 4 Reverse angle of FIG. 1.

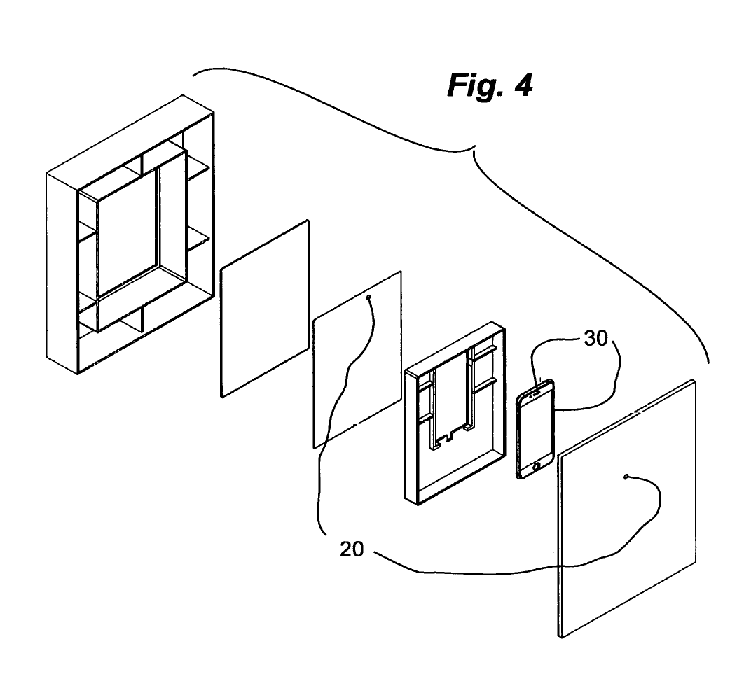

FIGS. 5a-f The invention seen from all sides.

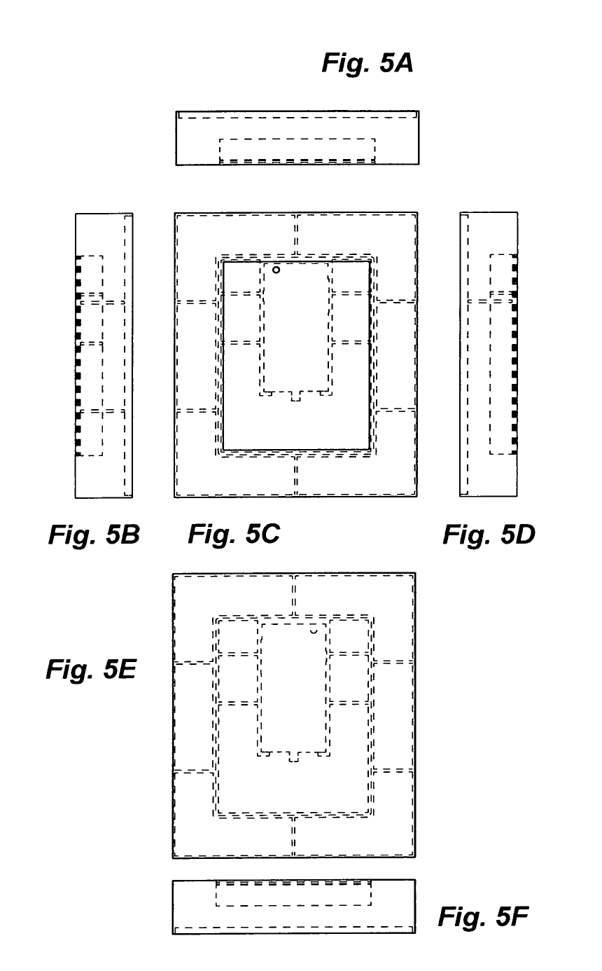

### DETAILED DESCRIPTION

A camera support and concealment device (10) comprises a hollow frame member (12) having a center opening (16) therethrough and an opened back portion (17). A transparent panel (14) is installed within the center opening (16) of the hollow frame member (12) frontwardly of an opaque panel (18) such as a picture or painting.

The opaque panel (18) has a spy hole (20) therein and is installed frontwardly of a concealment compartment member (22).

The hollow frame member (12) is further comprised of a backing board member (24). The center opening (16) has a ridge member (19) there around adapted to hold said panels and said camera support and concealment device (10) thereon.

The concealment compartment member (22) has an opening (26) that is configured and sized to frictionally hold an electronic device (28) equipped with a camera. Such devices (28) come in the guise of smart phones or tablets.

Besides having concealment compartment members (22) that are sold with a variety of specifically sized and shaped openings (26) to cater to specific makes and models of popular smart phones, because of the large variety of such devices (28), the concealment compartment member (22) can be made of a material that is easy to cut while still being rigid so as to maintain its given shape and the device (28) therein. Alternatively, an opening having resiliently deformable members (not shown) can provide for a dynamically adaptable opening (26) of variable sizes. The concealment compartment member (22) also includes a ridge member (19′) to hold the device (28).

There is ample hollow space around the concealment compartment member (22) and within the hollow frame member (12) to conceal larger batteries or cables.

The hollow frame member (12) has a plurality of rib members (32) to increase its structural integrity.

The camera support and concealment device (10) can be hung on wall or placed on a table when using an appropriate bracket or stand as are known in the art of picture frames. With this installation, viewing the area located frontwardly of the camera support and concealment device (10) is possible. With suitable software, the device (28) could further be triggered only if movement is detected. With suitable software and with a suitable network, the video can be either recorded and/or transmitted wirelessly or through network wires, to a predetermined receiving computer or smart phone.

It is noted that other alternative camera support and concealment devices (10) could be used that are not in the form of a picture frame. For example, a radio, a clock or any other object that would not look suspicious in the environment where it would be installed, could be used to support and conceal a camera with a result similar to the one described hereinabove.

Also, since most devices (28) have cameras (30) on both faces, it could be conceivable to have two spy holes (20) so that two cameras (30) could actually film two sides simultaneously and thus cover an almost 360 degree coverage.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A camera support and concealment device comprising a hollow frame member having a center opening therethrough and an opened back portion; a transparent panel adapted to fit within said frame member center opening; an opaque panel adapted to fit within said frame member center opening adjacent a backside of said transparent panel, and including at least one spy hole therethrough; a concealment compartment member adapted to fit within said frame member center opening adjacent a backside of said opaque panel, and including an opening therethrough adapted to hold a device that includes at least one camera therein, such that said at least one camera is capable of being aligned and capturing images through said concealment compartment member opening, said at least one opaque panel spy hole, said transparent panel, and said frame member center opening; and a backing board member adapted to removably attach to said frame member, cover said opened back portion, and enclose said panels, said concealment compartment, and said device within said frame member.

2. The device of claim 1, wherein said frame member center opening includes a ridge member there around adapted to hold said panels and said concealment compartment thereon.

3. The device of claim 2, wherein said hollow frame member includes a plurality of rib members attached between inner side walls of said frame member and said center opening ridge member to thereby increase the strength and rigidity of said device.

4. The device of claim 1, wherein said backing board member includes a bracket member thereon adapted to hold said device in a standing position upon a flat surface when in use.

5. The device of claim 1, wherein said opaque panel includes two spy holes adapted to allow the use of two cameras within said device.

6. The device of claim 1, wherein said concealment compartment member is made from injection moulded plastic.

7. The device of claim 1, wherein said concealment compartment member opening includes a ridge member there around adapted to hold said device that includes said at least one camera thereon; and wherein said ridge member is made from resilient injection moulded rubber

8. A combination of a camera device and a camera support and concealment device, said combination comprises a camera device including at least one camera therein; and a camera support and concealment device comprising a hollow frame member having a center opening therethrough and an opened back portion; a transparent panel adapted to fit within said frame member center opening; an opaque panel adapted to fit within said frame member center opening adjacent a backside of said transparent panel, and including at least one spy hole therethrough; a concealment compartment member adapted to fit within said frame member center opening adjacent a backside of said opaque panel, and including an opening therethrough adapted to hold said camera device therein, such that said at least one camera is capable of being aligned and capturing images through said concealment compartment member opening, said at least one opaque panel spy hole, said transparent panel, and said frame member center opening; and a backing board member adapted to removably attach to said frame member, cover said opened back portion, and enclose said panels, said concealment compartment, and said camera device within said frame member.

9. The combination of claim 8, wherein said frame member center opening includes a ridge member there around adapted to hold said panels and said concealment compartment thereon.

10. The combination of claim 9, wherein said hollow frame member includes a plurality of rib members attached between inner side walls of said frame member and said center opening ridge member to thereby increase the strength and rigidity of said device.

11. The combination of claim 8, wherein said backing board member includes a bracket member thereon adapted to hold said device in a standing position upon a flat surface when in use.

12. The combination of claim 8, wherein said opaque panel includes two spy holes adapted to allow the use of two cameras within said camera device.

13. The combination of claim 8, wherein said concealment compartment member is made from injection moulded plastic.

14. The combination of claim 8, wherein said concealment compartment member opening includes a ridge member there around adapted to hold said device that includes said at least one camera thereon; and wherein said ridge member is made from resilient injection moulded rubber.

15. The combination of claim 8, wherein said camera device includes software that detects motion outside of said frame member center opening, takes a picture image when said movement is detected, and is adapted to record said picture image.

16. The combination of claim 8, wherein said camera device includes software that detects motion outside of said frame member center opening, takes a picture image when said movement is detected, and is adapted to send said picture image wirelessly to a an external recording device.
